(19) United States
(12) Patent Application Publication
(10) Pub. No.: US 2018/0238280 A1
(43) Pub. Date: Aug. 23, 2018

(54) FUEL SUPPLY APPARATUS FOR TWO-CYLINDER GENERAL-PURPOSE ENGINE

(71) Applicant: NIKKI CO., LTD., Kanagawa-ken (JP)

(72) Inventors: Yukinori Suematsu, Kanagawa - Ken (JP); Teruyuki Wakabayashi, Kanagawa - Ken (JP)

(21) Appl. No.: 15/898,801

(22) Filed: Feb. 19, 2018

(30) Foreign Application Priority Data
Feb. 17, 2017 (JP) 2017-028037

(51) Int. Cl. F02M 57/04; F02M 37/00

(52) U.S. Cl. CPC F02M 57/04; F02B 75/22; F02M 37/007

(57) ABSTRACT

In a fuel supply apparatus, an injector and a throttle valve are provided in a throttle body, and the fuel supply apparatus is disposed between an intake manifold and an air cleaner of a two-cylinder general-purpose engine and supplies fuel adjusted to a predetermined air-fuel ratio to both cylinders of the two-cylinder general-purpose engine by one injector. The throttle body includes a fuel supply unit having the injector and an air amount control unit having the throttle valve. The fuel supply unit and the air amount control unit are formed of separate components that can be separated or joined.

### CROSS REFERENCE TO RELATED APPLICATION

This application claims priority to Japanese Application No. JP2017-028037 filed Feb. 17, 2017, which is hereby incorporated by reference in its entirety.

### TECHNICAL FIELD

The present invention relates to a fuel supply apparatus for a two-cylinder general-purpose engine and, in particular, to a fuel supply apparatus suitable for a V-type two-cylinder general-purpose engine used for such as a lawn mower and a generator.

### RELATED ART

In recent years, to respond to requirements for environmental measures such as improvement of fuel consumption and exhaust gas regulation even in a multi-cylinder general-purpose engine used for such as a lawn mower, a generator, a power engine used for water leisure, a fuel supply system using a carburetor (vaporizer) is switched to a fuel supply system (fuel injection system: FI) using an injector which is excellent in controllability of an air-fuel ratio for each cylinder.

However, although general-purpose engines are required to be compact and inexpensive considering the convenience of a final consumer because many of them are used as a power source for a working machine, in the general-purpose engines which are currently distributed, it is assumed that a carburetor is interposed between an air cleaner and an intake manifold. When shifting to the FI, due to changing a fuel supply apparatus, the connection structure of the intake manifold, which is a component of an engine system, and the connection structure of the air cleaner need to be completely changed. As a result, the manufacturing cost of the entire engine system increases.

Further, in a V-type two-cylinder engine that occupies most of general-purpose engines, two types of carburetors are used. One is a two-bore type carburetor that independently controls each cylinder, and another one is a single-bore type carburetor that controls both cylinders by one bore. Depending on the number of bores of the carburetor applied, it is necessary to change the connection structure to the intake manifold and the connection structure to the air cleaner in a new fuel supply apparatus. As a result, in the case of the two-bore type, two expensive injectors are required, which further increases the manufacturing cost.

### BACKGROUND

On the other hand, the inventors and applicants of the present invention have previously proposed, in JP 2003-106246 A, a fuel supply apparatus in which fuel is supplied by one injector in contact with an area between two intake passages connected to each cylinder of a two-cylinder general-purpose engine so as to realize cost reduction by reducing the number of injectors. However, since this fuel supply apparatus also has a structure that it cannot be directly connected to various types of existing general-purpose engines in addition to the need for a throttle body with two throttle valves, the cost reduction effect is not sufficient.

Furthermore, in recent years, a fuel supply system using a throttle (electronically controlled throttle) driven by an electronically controlled motor for the purpose of reducing running cost is also spreading. Even in general-purpose engines used for such as lawn mowers and generators, there is also a growing need to realize operation in a high efficiency range by using such the electronically controlled throttle.

When the fuel supply apparatus by FI is used in existing general-purpose engines while considering all the above-described requirements, it is assumed to use four types engines: a single-bore type mechanical throttle, a single-bore type electronically-controlled throttle, a two-bore type mechanically-controlled throttle, and a two-bore type electronically controlled throttle, and at least four types of fuel supply apparatuses need to be prepared. Therefore, it is considered difficult to achieve cost reduction.

### SUMMARY

An object of the present invention is to solve the above-described problem and to make it possible to apply a fuel injection system to various types of two-cylinder general-purpose engines at low cost.

According to the present invention, in a fuel supply apparatus, an injector and a throttle valve are provided in a throttle body, and the fuel supply apparatus is disposed between an intake manifold and an air cleaner of a two-cylinder general-purpose engine and supplies fuel adjusted to a predetermined air-fuel ratio to both cylinders of the two-cylinder general-purpose engine by one injector. The throttle body includes a fuel supply unit having the injector and an air amount control unit having the throttle valve. The fuel supply unit and the air amount control unit are formed of separate components that can be separated/joined.

As described above, in the throttle body of the fuel supply apparatus by a FI system, since a portion having the injector and a portion having the throttle valve are formed of separate components which can be separated and joined, while changing and combining the component on the injector side or on the throttle valve side according to the type of a general-purpose engine to be applied, the components can be easily applied to general-purpose engines. Therefore, in comparison with the case where every types of fuel supply apparatuses are prepared in which a mechanically controlled or electronically controlled throttle valve is integrated, with a structure corresponding to intake manifolds and air cleaners having different forms for each type of general-purpose engines, a fuel injection system can be applied to various types of general-purpose engines with low manufacturing cost.

Further, in this fuel supply apparatus, a fuel supply unit thereof is disposed on the downstream side of an air amount control unit, a joint end surface for connecting to the intake manifold is formed at a downstream end portion, and a joint end surface for connecting to an air cleaner is formed on an upstream end portion of the air amount control unit, such that the fuel supply apparatus can be easily disposed between the intake manifold and the air cleaner.

In this case, on the joint end surface on the air cleaner side of the air amount control unit, five bolt holes are penetrated and opened to attach to both a two-hole mounting flange of a single-bore air cleaner and a four-hole mounting flange of a two-bore air cleaner. The five bolt holes are also served as a bolt hole in which one bolt hole of the four bolt holes disposed rectangularly so as to communicate with each bolt hole of the four-hole mounting flange communicates with one of two bolt holes of the two-hole mounting flange. The fifth bolt hole which communicates with another one of the two bolt holes penetrates and opens on the opposite side across an intake passage of the bolt hole. In such a case, one air amount control unit can connect to both of the single-bore air cleaner and two-bore air cleaner as it is.

Further, in the above-described fuel supply apparatus, a fuel supply unit thereof corresponds to a single bore intake manifold having one straight intake passage or corresponds to two-bore intake manifold connecting to both of two intake passages of the two bore intake manifold by enlarging a diameter of one intake passage on the downstream side of an injector. In such a case, only by preparing components forming two-types of fuel supply units, it is possible to easily connect to both types of intake manifolds for single bore and two bores.

Furthermore, when a machine control type or electronic control type throttle valve can be used as a throttle valve of the air amount control unit in the above-described fuel supply apparatus, by preparing two types of air amount control units of the machine control type and the electronic control type and combining them appropriately with the above-described fuel supply unit, the fuel supply apparatus is applicable to various types of engines while responding to both of the machine control type and the electronic control type.

In addition, in the above-described fuel supply apparatus, if the application target is a V-type engine, in a situation where a space between engine heads is narrow, and the degree of freedom of arrangement of the fuel supply apparatus is low, the above-described advantage of the present invention becomes particularly prominent.

According to the present invention, in which a portion having an injector and a portion having a throttle valve in a throttle body of a fuel supply apparatus are formed of separate components to make it possible to separate and combine the portions, a fuel injection system for various types of two-cylinder general-purpose engines can be applied at low cost.

### BRIEF DESCRIPTION OF DRAWINGS

FIG. 1 is a front view of a fuel supply apparatus according to an embodiment of the present invention;

FIG. 2A is a left side view of an air amount control unit of the fuel supply apparatus illustrated in FIG. 1, and FIG. 2B is a front view of the air amount control unit illustrated in FIG. 2A;

FIG. 3A is a left side view of a mechanical air amount control unit combined instead of an electronic control-type air amount control unit illustrated in FIG. 1, and FIG. 3B is a front view of the air amount control unit illustrated in FIG. 3A;

FIG. 4A is a longitudinal sectional view taken along the center line of an intake passage indicating a state in which the fuel supply apparatus illustrated in FIG. 1 is interposed between an intake manifold and an air cleaner, and FIG. 4B is a left side view of the fuel supply apparatus illustrated in FIG. 4A;

FIG. 5A is a longitudinal sectional view of a fuel supply apparatus illustrated in FIG. 4A, in which a fuel supply unit corresponding to a single bore intake manifold is changed to a fuel supply unit corresponding to a two bore intake manifold, and FIG. 5B is a left side view of the fuel supply apparatus illustrated in FIG. 5A;

FIG. 6 is a front view indicating a state in which a carburetor is interposed between an intake manifold and an air cleaner;

FIG. 7 is a perspective view indicating a situation in which a single bore type carburetor is attached to an air cleaner; and

FIG. 8 is a perspective view indicating a situation in which a two-bore type carburetor is attached to an air cleaner.

### DETAILED DESCRIPTION

Hereinafter, an embodiment of the present invention will be described with reference to the drawings.

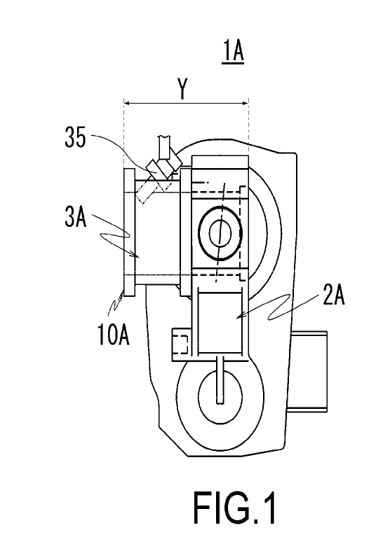

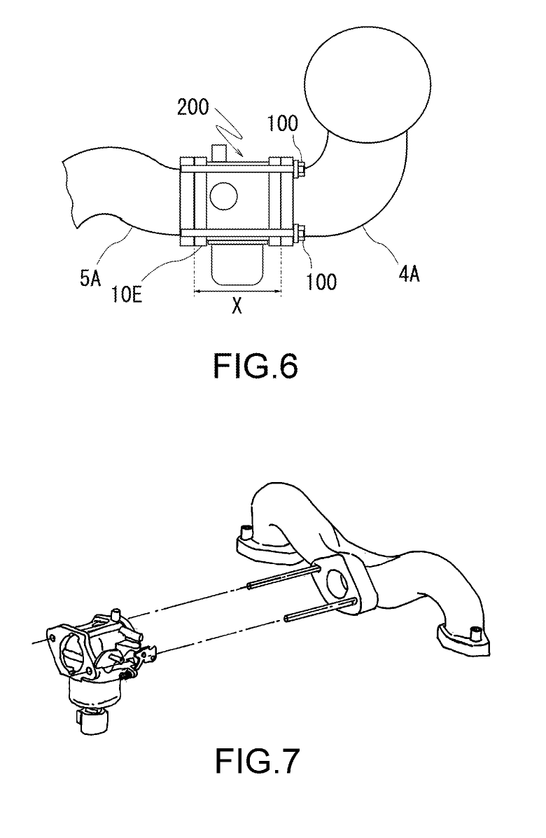

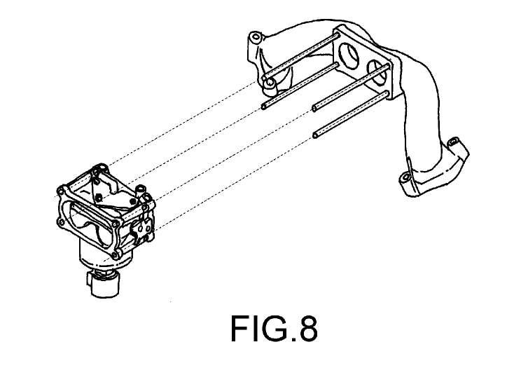

FIG. 1 illustrates a fuel supply apparatus 1A according to the present embodiment. The fuel supply apparatus 1A is assumed to be used in a V-type two-cylinder general-purpose engine. In the case where a fuel supply apparatus is arranged in such a general-purpose engine, conventionally, as illustrated in FIG. 6, a regulator 200 is generally interposed between an intake manifold 5A and an air cleaner 4A so as to fasten and fix them together with a long bolt 100.

Therefore, considering that a throttle body 10A in the fuel supply apparatus 1A according to the present embodiment is disposed in place of the regulator 200 of the existing engine system, the throttle body 10E of the regulator 200 has a width Y equal to the width X of the throttle body 10E of the regulator 200 and has a connection structure of bolt hole positions almost common to the regulator 200 on the connection end surfaces on both end sides, such that the throttle body 10A can be disposed between the existing intake manifold 5A and the air cleaner 4A as it is.

Also, the fuel supply apparatus 1A applies a FI system in which one injector 35 injects and supplies fuel adjusted to a predetermined air-fuel ratio to both cylinders of a two-cylinder general-purpose engine, and the throttle body 10A in the fuel supply apparatus 1A has a fuel supply unit 3A having the injector 35 on the downstream side of an air amount control unit 2A having a throttle valve (not illustrated). The air amount control unit 2A and the fuel supply unit 3A are formed of separate components separated on a surface perpendicular to a bore center (the center line of an intake passage), and that is a characteristic point of the present invention.

In this way, in the throttle body 10A, which is normally composed of one piece, a portion having the injector 35 and a portion having the throttle valve are formed of separate components, which can be easily separated and combined. As a result, a system can be realized in which the components on the injector side or the throttle valve side can be appropriately combined in accordance with the type of an engine to be applied.

That is, as indicated in the upper part of Table 1 below, in a two-cylinder general-purpose engine in total, there are four type systems in total, two types of fuel supply control systems of a single bore type (S) and a two bore type (T) and two types of air amount control systems of a mechanical type (M) and an electronic control type (E). Therefore, to supply fuel correspondingly, four types of fuel supply apparatuses are required. However, as described above, the fuel supply unit having an injector and the air amount control unit having a throttle valve are formed of separate components, and by adopting a system corresponding to existing engines by combining the components, it is expected to drastically reduce production cost.

TABLE 1

ENGINE TYPE
ENGINE REQUIREMENTS
ITEMS
GENERAL APPARATUS
FUEL SUPPLY UNIT
AIR AMOUNT CONTROL UNIT
INTAKE MANIFOLD
AIR CLEANER
PRESENT INVENTION
SINGLE BORE
MECHANICAL TYPE
ELECTRONIC TYPE
NEW
EXISTING PRODUCT (FOR CARBURETOR)
TWO BORES

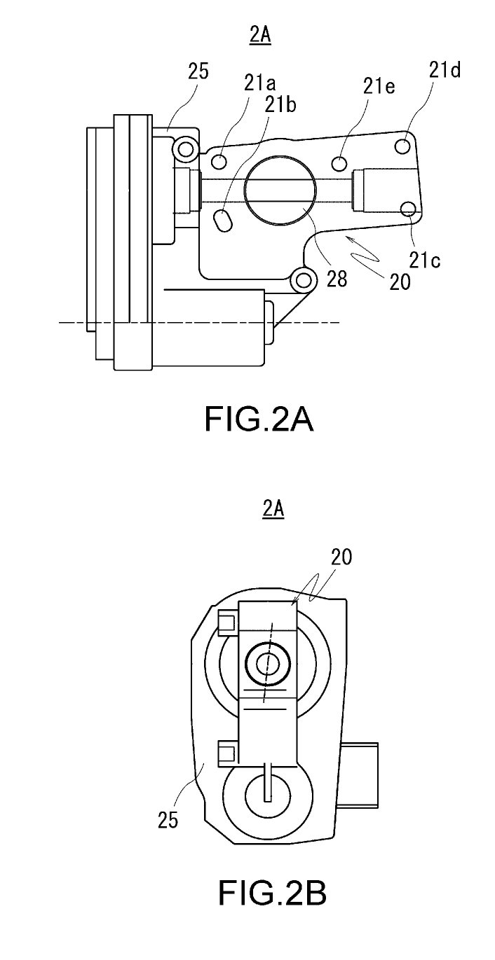

FIG. 2A is a left side view of the air amount control unit 2A in the fuel supply apparatus 1A, and FIG. 2B is a front view thereof. The air amount control unit 2A includes an electric control throttle for electronically controlling operation of a drive unit 25 using an electric motor and controls opening and closing of a throttle valve 28 disposed in an intake passage 50a by electronic control to realize an ideal air-fuel ratio by ensuring a sufficient air flow rate.

Five bolt holes 21a, 21b, 21c, 21d, and 21e penetrating from a joint end surface on the side of an air cleaner to an joint end surface on the side of the fuel supply unit 3A are provided in a body 20 included in the air amount control unit 2A. The bolt holes 21a, 21b, 21c, 21d, and 21e can be attached to both a single-bore two-hole mounting flange and a two-bore four-hole mounting flange on the side of the air cleaner, and that is an important characteristic in the present embodiment.

That is, in the case where, to communicate with each bolt hole of the four-hole mounting flange of the air cleaner, among the four bolt holes 21a, 21b, 21c, and 21d arranged rectangularly in the body 20, an air cleaner of one bolt hole 21b is a two-hole mounting flange, the bolt hole 21b serves as a bolt hole communicating with one of the two bolt holes, and the fifth bolt hole 21e communicating with the other one of the two bolt holes on the opposing side across the intake passage 50a of the bolt hole 21b is penetrated and opened. Incidentally, the bolt hole 21b is enlarged in the rotation direction around a bore center to cope with the arrangement angle of the two-hole type flange and the deviation of the arrangement angle of the two-hole type flange.

The reason for adopting such a configuration is that, to correspond to the four types of engines described in the upper part of Table 1, although it is necessary to prepare four types of air amount control units of either a single bore type or a two bore type and a mechanical type or electric type, the joint end surface on the air cleaner side can correspond to both single bore two hole type and two bore four hole type by one air control unit as described above, and it is sufficient to prepare two types of air amount control units (M) and (E) as described in the lower part of Table 1.

In addition, since it is difficult to think that the production quantities of the above-described four types of engines are equal, when four types of fuel supply apparatuses are prepared, depreciation of small quantity production equipment such as throttle body molds is difficult to advance. If the combination system according to the present invention is used, the possibility is reduced to a half in simple calculation, and this is considered extremely advantageous in reducing the production cost.

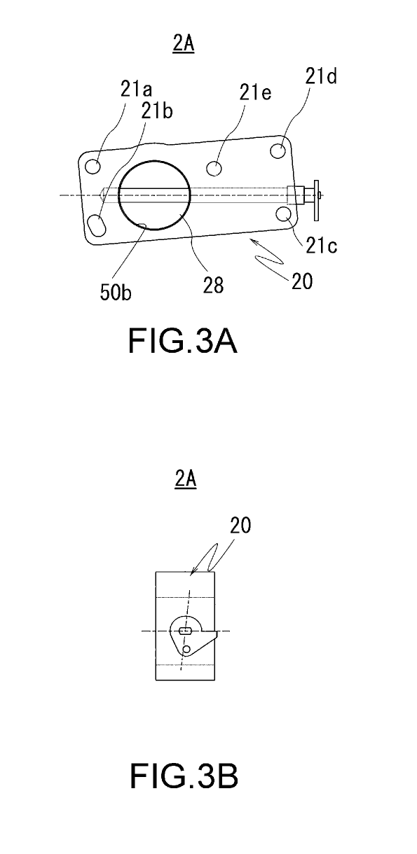

On the other hand, FIG. 3A illustrates a left side view of the air amount control unit 2B including a mechanical throttle, and FIG. 3B illustrates a front view thereof. The air amount control unit 2B mechanically controls opening and closing the throttle valve 29 disposed in an intake passage 50b penetrating a body 22, while linking with an engine governor (governor) to realize an ideal air-fuel ratio by ensuring an optimum air flow rate.

Similar to the above-described air amount control unit 2A, in the air amount control unit 2B, among the four bolt holes 23a, 23b, 23c, and 23d arranged rectangularly penetrating the body 22, one bold hole 23b serves as a bolt hole communicated with one of the two bolt holes of the two-hole mounting flange of the air cleaner. The fifth bold hole 23e communicating with another one of the two bolt holes penetrates and opens on the opposite side across the intake passage 50b of the bolt hole 23b so as to fasten and fix by a bolt corresponding to both of the four hole type and the two hole type as described above.

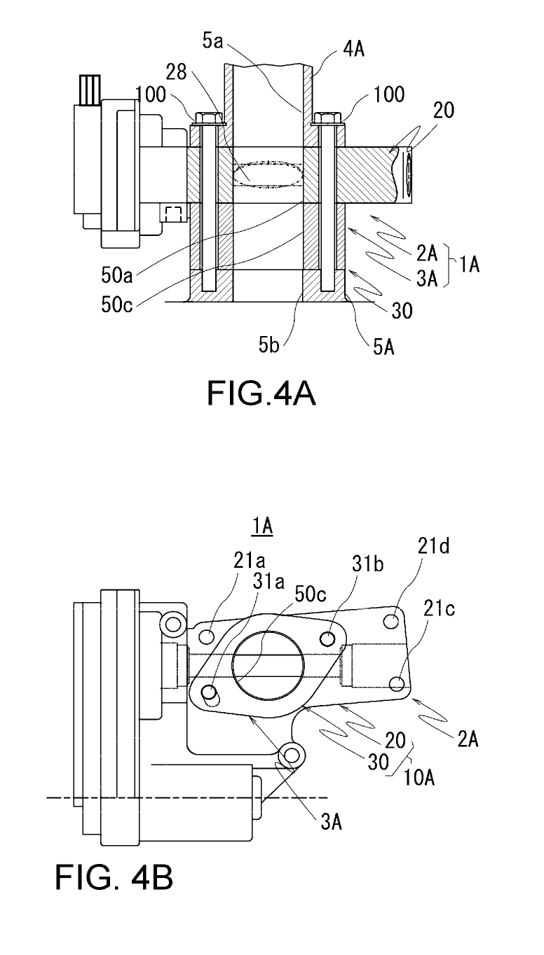

FIG. 4A is a longitudinal sectional view indicating a state in which the fuel supply apparatus 1A of FIG. 1 is interposed between a single-bore two-hole intake manifold 5A and a single bore two-hole air cleaner 4A. FIG. 4B is a left side view of the fuel supply apparatus 1A. The one intake passage 5a formed in the air cleaner 4A is communicated with the intake passage 50a of the air amount control unit 2A having the throttle valve 28, the intake passage 50c of the fuel supply unit 3A having the injector 35 (not illustrated), and one intake passage 5b formed in the intake manifold 5A. These four components are integrally fastened and fixed by two bolts 100 and 100.

As illustrated in FIG. 4B, among the five bolt holes 21a, 21b, 21c, 21d, and 21e of the air amount control unit 2A, the two bolts 100 and 100 are fastened and fixed by inserting into the bolt holes 21b and 21e and the bolt holes 31a and 31b of the fuel supply unit 3A, and the bolt holes 21a, 21c, and 21d of the air amount control unit 2A are not used.

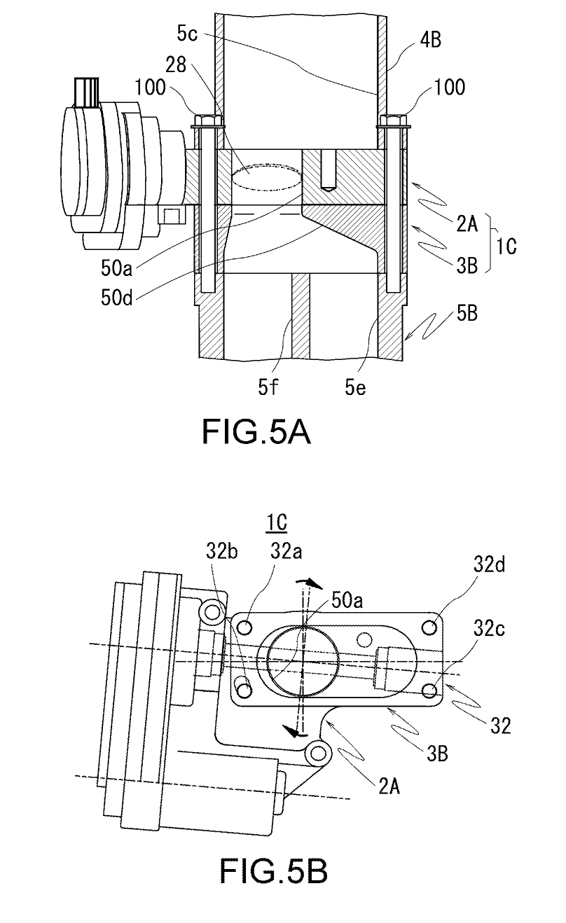

On the other hand, FIG. 5A indicates a longitudinal sectional view in the case where a fuel supply apparatus 1C according to the present invention is interposed between a two-bore four-hole intake manifold 5B and a two-bore four-hole air cleaner 4B. In the present embodiment, while including the air amount control unit 2A in the fuel supply apparatus 1A, in place of the fuel supply unit 3A compatible with a single-bore intake manifold having one straight intake passage 50c, the fuel supply unit 3B compatible with a two-bore intake manifold is disposed. In the fuel supply unit 3B, one intake passage 50d has a diameter enlarged on the downstream side of an injector and is connected to both of the intake passages 5e and 5f opened in parallel at the two bore intake manifold 5B.

In the case of this fuel supply apparatus 1C, the air amount control unit 2A fixed by the two hole type in the fuel supply apparatus 1A illustrated in FIG. 4B is positioned by rotating in the arrow direction around a bore center (center line of the intake passage 50a) as illustrated in FIG. 5B such that four bolt holes 21a, 21b, 21c, and 21d are matched to the position of four bolt holes provided to a mounting flange of the four-hole air cleaner 4B, and also four bolt holes 32a, 32b, 32c, and 32d provided in the body 32 of the four-hole type fuel supply unit 3B are matched to the position. The bolt holes and four bolt holes provided to a mounting flange of the four-hole intake manifold 5B are aligned and integrally fastened and fixed by four bolts 100.

As described above, in the air amount control unit 2A provided with the electronic control type throttle valve 28, a joint end surface on the side of an air cleaner can be connected to both the single-bore two-hole type and the two-bore four-hole type air cleaners 4A and 4B. Further, the air amount control unit 2A can be directly connected to both the single-bore fuel supply unit 3A and the two-bore fuel supply unit 3B. Although not illustrated, the same applies to the case of combining the air amount control unit 2B having the mechanical throttle valve 29.

As described above, conventionally, in the case where the fuel supply apparatus is provided in the four types of engines described in the upper part of Table 1, four dedicated throttle bodies are required. On the other hand, in the fuel supply apparatus according to the present invention, as described in the bottom part of Table 1, since two air system components and two fuel supply system components are combined, the production quantity of each component is doubled in simple calculation, and it is expected that the production cost is drastically reduced. In addition, there is an advantage that the intake manifold and the air cleaner in the existing engine can be used as they are.

Further, since it is rare that the production quantities of the above-described four types of engines are equal, there has been a risk that it is difficult to advance the depreciation of production equipment including throttle body molds of which production quantity is small. However, by using the combination system according to the present invention, the risk is reduced to a half in simple calculation, and therefore the effect of reducing the production cost in the long term sense is also greatly expected.

As described above, according to the present invention, a fuel injection system can be applied to various types of two-cylinder general-purpose engines at low cost.

What is claimed is:

1. A fuel supply apparatus for a two-cylinder general-purpose engine, comprising:
a throttle body including a fuel supply unit having an injector; and
an air control unit having a throttle valve;
wherein the injector and the throttle valve are provided in the throttle body,
wherein the fuel supply apparatus is disposed between an intake manifold of a two-cylinder general-purpose engine and an air cleaner and configured to supply fuel adjusted to a predetermined air-fuel ratio to both cylinders of the two-cylinder general-purpose engine by the injector, and
the fuel supply unit and the air amount control unit are formed of separate components that can be separated or joined.

2. The fuel supply apparatus for the two-cylinder general-purpose engine according to claim 1, wherein the fuel supply unit is disposed on a downstream side of the air amount control unit, the fuel supply apparatus further comprising:
a first joint end surface for connecting to the intake manifold and formed at a downstream end portion of the air amount control unit, and
a second joint end surface for connecting to the air cleaner and formed at an upstream end portion of the air amount control unit.

3. The fuel supply apparatus for the two-cylinder general-purpose engine according to claim 2, wherein, on the second joint end surface on the air cleaner side of the air amount control unit, five bolt holes are penetrated and opened to attach to both a two-hole mounting flange of a single-bore air cleaner and a four-hole mounting flange of a two-bore air cleaner,
the five bolt holes are also served as a bolt hole in which one bolt hole of the four bolt holes disposed in a rectangular configuration so as to communicate with each bolt hole of the four-hole mounting flange communicates with one of two bolt holes of the two-hole mounting flange, and
a fifth bolt hole which communicates with another one of the two bolt holes penetrates and opens on the opposite side across an intake passage of the one bolt hole.

4. The fuel supply apparatus of the two-cylinder general-purpose engine according to claim 1, wherein the fuel supply unit
corresponds to a single-bore intake manifold having one straight intake passage, or
corresponds to a two-bore intake manifold in which a diameter of one intake passage is enlarged on a downstream side of an injector and connected to both of two intake passages of the two-bore intake manifold.

5. The fuel supply apparatus for a two-cylinder general-purpose engine according to claim 1, wherein a throttle valve of the air amount control unit is a machine control type or an electronic control type.

6. The fuel supply apparatus for a two-cylinder general-purpose engine according to claim 1, wherein the application target is a V-type engine.

7. The fuel supply apparatus of the two-cylinder general-purpose engine according to claim 2, wherein the fuel supply unit
corresponds to a single-bore intake manifold having one straight intake passage, or
corresponds to a two-bore intake manifold in which a diameter of one intake passage is enlarged on a downstream side of the injector and connected to both of two intake passages of the two-bore intake manifold.

8. The fuel supply apparatus for the two-cylinder general-purpose engine according to claim 2, wherein a throttle valve of the air amount control unit is a machine control type or an electronic control type.

9. The fuel supply apparatus for the two-cylinder general-purpose engine according to claim 2, wherein the application target is a V-type engine.

10. The fuel supply apparatus of the two-cylinder general-purpose engine according to claim 3, wherein the fuel supply unit
corresponds to a single-bore intake manifold having one straight intake passage, or
corresponds to a two-bore intake manifold in which a diameter of one intake passage is enlarged on a downstream side of the injector and connected to both of two intake passages of the two-bore intake manifold.

11. The fuel supply apparatus for the two-cylinder general-purpose engine according to claim 3, wherein a throttle valve of the air amount control unit is a machine control type or an electronic control type.

12. The fuel supply apparatus for the two-cylinder general-purpose engine according to claim 3, wherein the application target is a V-type engine.

13. The fuel supply apparatus for the two-cylinder general-purpose engine according to claim 4, wherein a throttle valve of the air amount control unit is a machine control type or an electronic control type.

14. The fuel supply apparatus for the two-cylinder general-purpose engine according to claim 4, wherein the application target is a V-type engine.

15. The fuel supply apparatus for the two-cylinder general-purpose engine according to claim 5, wherein the application target is a V-type engine.
